(19) United States
(12) Patent Application Publication
(10) Pub. No.: US 2004/0108832 A1
(43) Pub. Date: Jun. 10, 2004

(54) Compact wall outlet assembly

(76) Inventor: Feng-Shen Hsiao, Taipei (TW)

Correspondence Address: Cooper & Dunham LLP, 1185 Avenue of the Americas, New York, NY, 10036, US

(21) Appl. No.: 10/313,626

(22) Filed: Dec. 6, 2002

(51) Int. Cl. H02J 7/00

(52) U.S. Cl. 320/107

(57) ABSTRACT

A compact wall outlet assembly has a housing composed of a front casing and a rear casing. Inside the housing, at least one circuit board is disposed and electrically connected with several battery charging conductors. A top edge of the housing is configured as a multi-step shape and has a pair of contact plates, which is connected to the circuit arranged thereon for electrically contacting two opposite electrodes of a battery to be measured for electricity stored in it. The front casing is further defined with multiple through windows to correspond to the battery charging conductors, whereby the battery charging conductors are able to be exposed through the front casing to retain batteries to be charged.

### BACKGROUND OF THE INVENTION

1. Field of the Invention

The invention is related to a compact wall outlet assembly, and more particularly to a wall outlet assembly integrated with functions of battery charging and battery electricity measuring.

2. Description of Related Arts

Homes and other places have many electrical appliances that create an excessive demand on electricity outlets, and this is aggravated by the recent trend of computer peripheral devices. To solve this problem, the conventional wall outlet having multiple sockets formed thereon is presented to expand the number of the outlets. However, the conventional wall outlet only server to expand the number of the outlets and has no additional functions. So for a conventional wall outlet, its commercial worth in the market is generally hard to raise and is accordingly difficult to compete with other products of the same kind.

To overcome the mentioned shortcomings, a compact wall outlet assembly in accordance with the present invention obviates or mitigates the aforementioned problems.

### SUMMARY OF THE INVENTION

The objective of the present invention is to provide a compact wall outlet assembly incorporating with functions of battery charging and measurement of battery content.

To accomplish the objective, the compact wall outlet assembly is constructed of:

a housing composed of a front casing and a rear casing;

at least one plug composed of multiple conductive plates that are arranged inside the housing for electrical connection in an outlet in a wall;

a first circuit board, which is placed inside the housing, electrically connecting a plurality of contacting plates disposed along a periphery of the housing for measuring battery electricity;

a second circuit board, which is placed inside the housing, electrically connected with a plurality of battery charging conductors and a voltage transformer, wherein the voltage transformer obtains AC voltage from the outlet through the at least one plug and converts the AC voltage to DC voltage to charge batteries.

The features and structure of the present invention will be more clearly understood when taken in conjunction with the accompanying figures.

### BRIEF DESCRIPTION OF THE DRAWINGS

FIG. 1 is an exploded perspective view of a compact wall outlet assembly in accordance with the present invention;

FIG. 2 is a plan view of the compact wall outlet assembly in accordance with the present invention, wherein a top portion of a front casing is omitted to show a circuit board arranged inside the compact wall outlet assembly;

FIG. 3 is perspective view of the compact wall outlet assembly of the present invention;

FIG. 4 is an operational view of the compact wall outlet assembly of the present invention; and

FIG. 5 is a schematic view showing a cover is moved pivotally.

### DETAILED DESCRIPTION OF THE PREFERRED EMBODIMENT

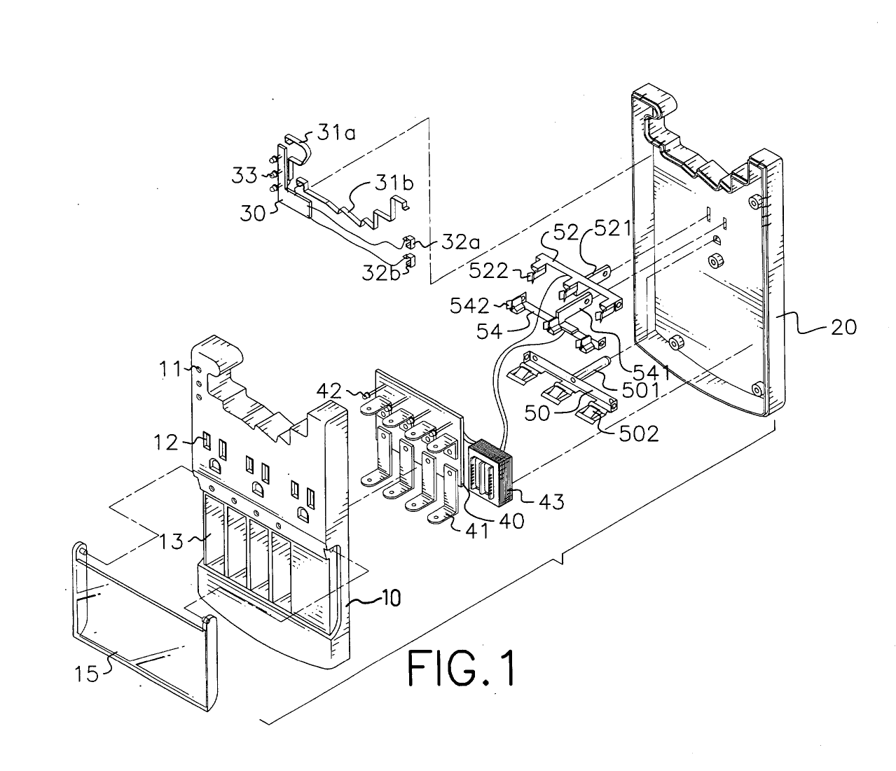

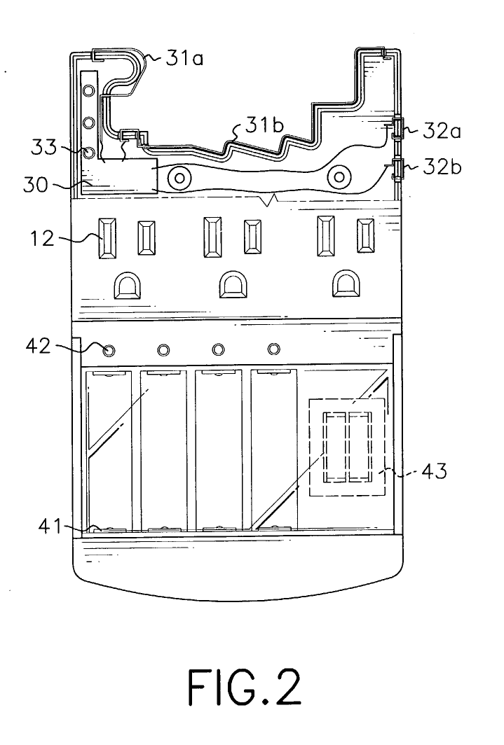

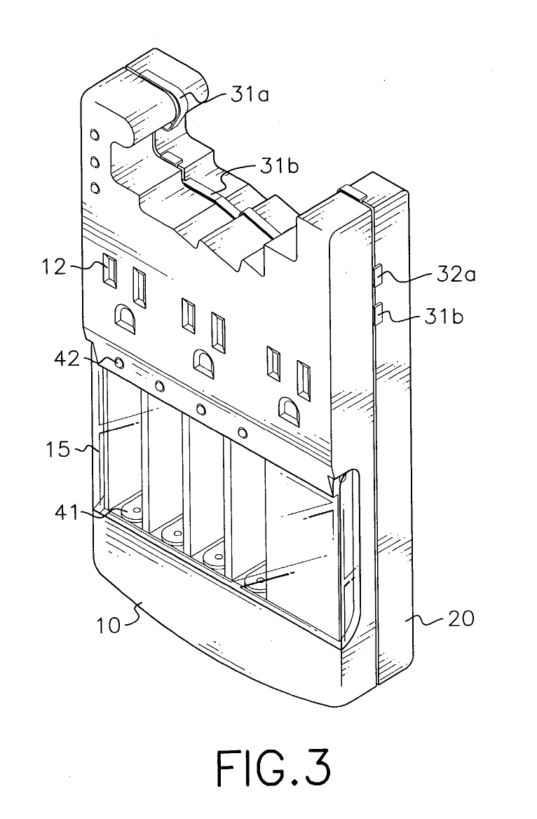

With reference to FIGS. 1, 2 and 3, a compact wall outlet assembly in accordance with the present invention has a housing composed of a front casing (10) and a rear casing (20). Inside the housing, a first circuit board (30), a second circuit board (40), a grounding plate (50) and a pair of conductive plates (52 and 54) are disposed therein.

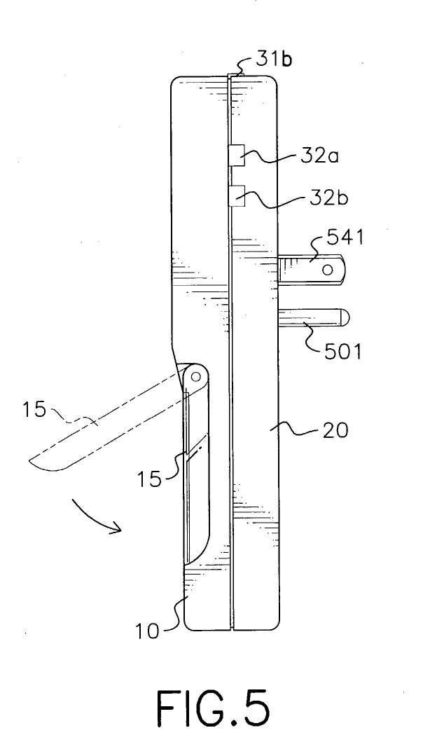

Both the front casing (10) and the rear casing (20) are configured to have a substantially multi-step shape in which different size batteries are able to be properly retained. The front casing (10) has a front surface on which multiple through holes (11), sockets (12) and battery windows (13) are defined. In the embodiment, the front casing (10) has four battery windows (13) to receive batteries (not shown) to be charged. Further, openings (14) defined at the front surface are respectively located to correspond to one battery window (13). A cover (15) is further pivoted at opposite sides of the front casing (10) to cover a region where the battery windows (13) defined (as shown in FIG. 5).

For the grounding plate (50) and the conductive plates (52 and 54), each provides a protrusion (501,521 and 541) to collectively form a plug that extends through the rear casing (20) for insertion into an outlet (not shown) in a wall. Furthermore, each plate (50, 52 and 54) is integrally formed with three contacts (502, 522 and 542) so as to form three sets of contacts to respectively correspond to the three sockets of the front casing (10).

The first circuit board (30) is connected with three LEDs (33) and two pairs of contacting plates (31a, 31b, 32a and 32b) made of metal sheets. The first pair of contacting plates (31a, 31b), having a corresponding shape of the top edge, is arranged along the top edge of the rear casing (20) for contacting with batteries. The second pair of contacting plates (32a, 32b) located at one side of the rear casing (20) is composed of two rectangular conductive sheets so as to contact to two opposite electrodes of a 9-volt battery that usually forms a rectangular shape with two opposite electrodes collectively disposed at one end. The three LEDs (33), preferably having different colors from each other, are used for indicating a determined voltage of the battery being measured.

With regard to the second circuit board (40), multiple charging conductors (41), charging indicating lights (42) and a voltage transformer (43) are all connected to the second circuit board (40). The transformer (43) connected with the grounding plate (50) and the conductive plates (52 and 54) is applied to transform the AC power to DC power for charging batteries.

In this embodiment, the battery electricity measuring and battery charging are respectively achieved by the first circuit board (30) and the second circuit board (40). However, it is to be appreciated that to integrate the two functions on a single circuit board is also feasible.

When foregoing components are assembled together, the LEDs (33) and the charging indicating lights (42) all protrude from the through holes (11) and the openings (14). Further, the charging conductors (41) are correspondingly inside the windows (13) to receive rechargeable batteries.

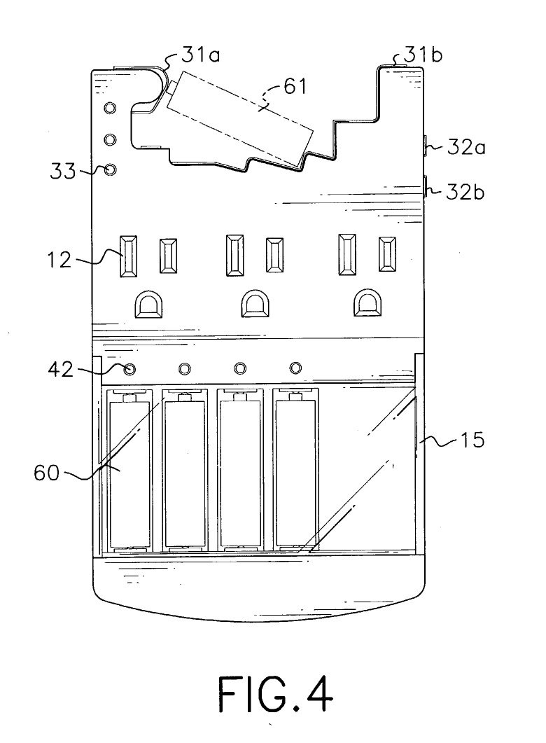

With reference to FIG. 4, multiple rechargeable batteries (60) are retained in the charging conductors (41) and each battery (60) is able to obtain a charging current generated from the transformer (43). Furthermore, a battery (61) to be measured for its residue voltage is leaned, with the positive and negative electrodes, against the first pair of contacting plates (31a, 31b). The design purpose of the multi-steps shape top edge of the housing is to allow different sizes batteries to be properly and correspondingly disposed on the top edge so as to contact the two plates (31a, 31b).

The foregoing description of the preferred embodiments of the present invention is intended to be illustrative only and, under no circumstances, should the scope of the present invention be restricted by the description of the specific embodiment.

What is claimed is:

1. A wall outlet assembly comprising:
a housing composed of a front casing and a rear casing, wherein at least one plug is protruded from the housing for insertion into an outlet in a wall; and
at least one circuit board, which is placed inside the housing and electrically connects to the at least one plug, connecting multiple contacting plates disposed along a circumstance of the housing for electrically adapting to contact with batteries to be measured for electricity in the batteries, wherein the at least one circuit board further connects with multiple battery charging conductors that are adapted to receive rechargeable batteries.

2. The wall outlet assembly as claimed in claim 1, wherein both top edges of the front casing and the rear casing are formed as a substantially multi-step shape and the multiple contacting plates are composed of two pairs of metal plates, wherein the first pair of contacting plates is arranged along the top edges, and the second pair of contacting plates is arranged at one side of the housing.

3. The wall outlet assembly as claimed in claim 2, wherein the front casing is defined with multiple through windows to correspond to the multiple battery charging conductors and defined with multiple sockets.

4. The wall outlet assembly as claimed in claim 3, wherein a voltage transformer is placed inside the housing and connected to the at least one circuit board.

5. The wall outlet assembly as claimed in claim 4, further comprising:
a grounding plate and two conductive plates, wherein each plate provides a protrusion to collectively construct the least one plug and each further integrally forms multiple contacts to correspond to the sockets.

6. The wall outlet assembly as claimed in claim 5, wherein multiple LEDs are set on the at least one circuit board and protrude from the front casing for indicating residue electricity of a battery that contacts with either the first pair of conductive plates or the second pair of conductive plates.

7. The wall outlet assembly as claimed in claim 6, wherein a cover is further pivoted to the housing to cover a region where the multiple through windows are defined.
